(19) United States
(12) Patent Application Publication
(10) Pub. No.: US 2012/0187879 A1
(43) Pub. Date: Jul. 26, 2012

(54) ZERO-VOLTAGE-TRANSITION SOFT SWITCHING CONVERTER

(76) Inventors: Cosmin Galea, Soenderborg (DK); Huai Yu Lin, Tallahassee, FL (US)

(21) Appl. No.: 13/384,669

(22) PCT Filed: Jul. 21, 2010
(86) PCT No.: PCT/US10/42687

§ 371 Date: Mar. 12, 2012

(30) Foreign Application Priority Data
Jul. 21, 2009 (DK) PA 2009 00887

(51) Int. Cl. H02P 6/14; H02M 7/5387

(52) U.S. Cl. 318/400.29; 363/132

(57) ABSTRACT

A zero-voltage-transition soft switching converter (14) for converting a DC voltage comprises a load output terminal (13); a main switching bridge comprising at least one main switch (S1; S2) and an auxiliary circuit (15) connected to the main switching bridge. The auxiliary circuit comprises an auxiliary switch (SX1); auxiliary diodes (D_{X1}, D_{X10}) connected to positive and negative DC voltages and to a diode connection point; and a coupled inductor (T_{X1}) having two coupled windings (Lᵣ₁; Lᵣ₂), connected between the load output terminal and the auxiliary switch and the diode connection point, respectively. The auxiliary circuit is connected to the main switching bridge to block currents in one direction between the main switching bridge and the auxiliary circuit, a residual magnetizing current otherwise freewheeling through a turned-on main switch and an auxiliary diode is reset in each switching cycle and thus no longer accumulated.

### BACKGROUND

The disclosure relates to a zero-voltage-transition soft switching converter for converting a DC voltage.

Zero-voltage-transition (ZVT) soft switching inverters for converting a DC voltage to an AC voltage are widely used for high frequency and medium- or high-power conversion applications. Several different ZVT topologies have been suggested, which typically comprise a main switching bridge and an auxiliary switching circuit, where switches in the auxiliary circuit assist the main switches to achieve zero-voltage switching. One group of ZVT topologies is inductor-coupled ZVT inverters utilizing the coupling effect of two inductors. These circuits can also be used as DC to DC converters.

This disclosure further relates to ZVT converters using coupled inductors, which belong to this group. Such converters are generally described in e.g. Yu, H. et al. “Variable timing control for coupled-inductor feedback ZVT inverter”, Power Electronics and Motion Control Conference (PEMC), 2000, pages 1138-1143 vol. 3. and Dong, W. et al. “Generalized concept of load adaptive fixed timing control for zero-voltage-transition inverters”, Applied Power Electronics Conference and Exposition (APEC), 2001, pages 179-185 vol. 1.

Another known circuit uses saturable inductors between the coupled inductors and the main switching bridge.

Yet another known circuit is disclosed in Jae-Young Choi, et al. “A Novel Inductor-coupled ZVT Inverter with Reduced Harmonics and Losses”, Power Electronics Specialists Conference (PESC), 2001, pages 1147-1152 vol. 2. The modified inverter disclosed in this document adds an extra reset winding to the coupled inductors to reset the magnetizing current.

### SUMMARY

It is an object of this disclosure to provide a zero-voltage-transition soft switching converter that resets magnetizing currents and prevents the free-wheeling currents.

According to this disclosure the object is achieved in a zero-voltage-transition soft switching converter for converting a DC voltage, the converter comprising a first DC voltage rail for connection to a positive DC voltage; a second DC voltage rail for connection to a negative DC voltage; a load output terminal; a main switching bridge comprising at least one main switch connected between one of said first and second DC voltage rails and the load output terminal; and an auxiliary circuit connected to the main switching bridge and comprising: at least one auxiliary switch connected to one of said first and second DC voltage rails; a first auxiliary diode having a cathode connected to said first DC voltage rail and a second auxiliary diode having an anode connected to said second DC voltage rail, the anode of the first auxiliary diode and the cathode of the second auxiliary diode being connected to a diode connection point; and a coupled inductor having two coupled windings, of which a first winding is connected between the load output terminal and the at least one auxiliary switch, and a second winding is connected between the load output terminal and said diode connection point.

The object is further achieved in that the auxiliary circuit is connected to the main switching bridge, and is configured to block currents in one of the directions between the main switching bridge and the auxiliary circuit. In one example, the auxiliary circuit includes a blocking diode arranged to block currents in one of the directions between the main switching bridge and the auxiliary circuit. The blocking diode effectively blocks the residual magnetizing current otherwise freewheeling in a loop through a turned-on main switch and an auxiliary diode. In this way, this current is now reset in each switching cycle, and it is thus no longer accumulated. For unidirectional DC to DC converters the blocking diode alone solves the problem of resetting the residual magnetizing current.

In one embodiment of the converter, the main switching bridge comprises: a first main switch connected between the first DC voltage rail and the load output terminal; and a second main switch connected between the load output terminal and the second DC voltage rail.

The switches of the converter may be implemented with any type of electronically controlled switching element. In one embodiment, the at least one auxiliary switch is implemented by a transistor. The transistor may be an insulated-gate bipolar transistor or a MOSFET.

The auxiliary circuit may further comprise a third auxiliary diode arranged to allow a current to flow in one direction between the first winding of the inductor and one of said first and second DC voltage rails. When the auxiliary circuit further comprises a voltage source inserted in series with said third auxiliary diode, the voltage across the third auxiliary diode is reduced, and thus also the freewheeling current can be prevented.

In one embodiment, the converter comprises two auxiliary circuits, a first auxiliary circuit connected to the main switching bridge and configured to block currents from the main switching bridge to the first auxiliary circuit and a second auxiliary circuit connected to the main switching bridge and configured to block currents from the second auxiliary circuit to the main switching bridge. The use of two auxiliary circuits ensures that the converter can handle incoming as well as outgoing load currents. In one variation of this embodiment, the first auxiliary circuit includes a first blocking diode arranged to block currents from the main switching bridge to the first auxiliary circuit, and the second auxiliary circuit includes a second blocking diode arranged to block currents from the main switching bridge to the second auxiliary circuit.

In either case, the converter may be characterized in that the auxiliary switch of the first auxiliary circuit has one terminal connected to said first DC voltage rail and another terminal connected to the first winding of the coupled inductor of the first auxiliary circuit; the third auxiliary diode of the first auxiliary circuit is arranged to allow a current to flow from said second DC voltage rail to the first winding of the coupled inductor of the first auxiliary circuit; the auxiliary switch of the second auxiliary circuit has one terminal connected to said second DC voltage rail and another terminal connected to the first winding of the coupled inductor of the second auxiliary circuit; and the third auxiliary diode of the second auxiliary circuit is arranged to allow a current to flow from the first winding of the coupled inductor of the second auxiliary circuit to said first DC voltage rail.

Such a converter may be configured to convert the DC voltage to an AC voltage.

A three-phase zero-voltage-transition soft switching inverter for converting a DC voltage to a three-phase AC voltage may comprise three of the abovementioned converters having two auxiliary circuits, wherein the DC voltage rails of each converter are arranged to be coupled in parallel to said DC voltage and the load output terminals of the three converters are arranged to be connected to a three-phase load.

### BRIEF DESCRIPTION OF THE DRAWINGS

This disclosure will now be described more fully below with reference to the drawings, in which:

FIG. 1 shows an example of a known three-phase zero-voltage-transition soft switching inverter;

FIG. 2 shows a corresponding single phase circuit, which can be used as a DC to DC converter or as a single phase DC to AC inverter;

FIG. 3 illustrates how the circuit of FIG. 2 can be modulated to be used as a DC to DC converter;

FIG. 4 illustrates how the circuit of FIG. 2 can be modulated to be used as a DC to AC inverter;

FIG. 5 shows operation waveforms for a control scheme for the circuit of FIG. 2 operating in a ‘variable time delay’ mode (note that the same circuit can run in a ‘fixed time delay’ mode if the ratio of the two coupled windings is less than or equal to 0.5, thus n₂/n₁≧0.5);

FIGS. 6a, 6b, 6c, 6d, 6e, 6f and 6g illustrate stages in the circuit of FIG. 2 corresponding to the waveforms of FIG. 5;

FIG. 7 shows free-wheeling current paths in the circuit of FIG. 2;

FIG. 8 illustrates high-frequency harmonics in an inductor current in the circuit of FIG. 2 due to a freewheeling current;

FIG. 9 shows a residual magnetizing current in the circuit of FIG. 2;

FIG. 10 shows a simulation illustrating the level of the residual magnetizing current in a known circuit using a saturable inductor;

FIGS. 11a and 11b show how the residual magnetizing current can be reset by inserting a blocking diode in the circuit of FIG. 2;

FIGS. 12a, 12b and 12c illustrate how the blocking diode blocks the current path for the residual magnetizing current;

FIG. 13 shows a single phase converter circuit with two auxiliary circuits and two blocking diodes;

FIG. 14 illustrates that the residual magnetizing current is reset in each switching cycle;

FIG. 15 shows a three-phase inverter corresponding to the single phase converter of FIG. 13;

FIG. 16 shows the circuit of FIG. 1 la modified with an inserted voltage in the auxiliary circuit;

FIG. 17 shows a three-phase inverter modified with inserted voltages in the auxiliary circuits; and

FIG. 18 shows an alternate arrangement of a single phase converter circuit with two auxiliary circuits and two blocking diodes.

### DETAILED DESCRIPTION OF EMBODIMENTS

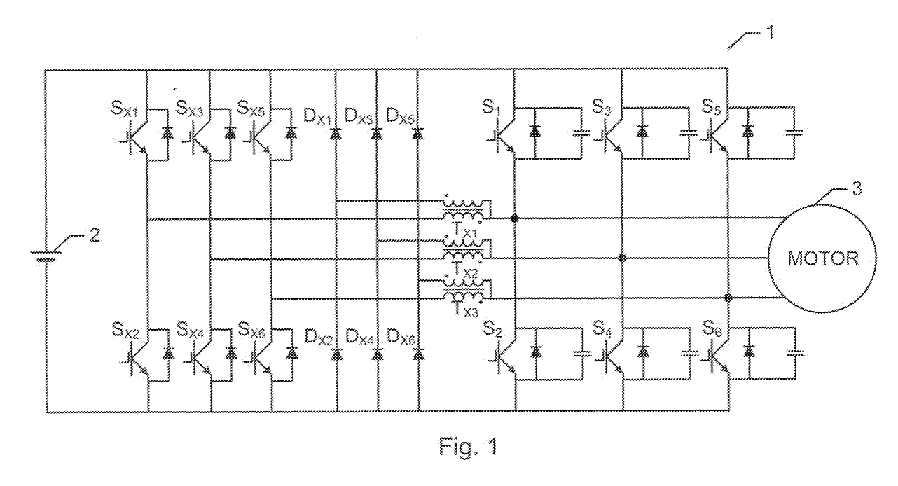

FIG. 1 shows an example of a three-phase zero-voltage-transition soft switching inverter, in which this disclosure can be used. Such inverters are widely used for high frequency and medium- or high-power conversion applications, e.g. for supplying power to inductor motors, such as motors used in electric vehicles. The inverter has a main switching bridge comprising six main switches S₁, S₂, S₃, S₄, S₅ and S₆, each switch having a diode and a capacitor connected across its terminals. The switches may be implemented with any type of electronically controlled switching element, such as bipolar transistors or field effect transistors, e.g. MOSFETs. Very often insulated gate bipolar transistors, IGBTs, are used as switching elements. The switches S₁, S₂, S₃, S₄, S₅ and S₆ are controlled to convert a DC voltage from a supply 2, e.g., in the form of a battery or in the form of an AC main power supply in communication with a rectifier, to a three phase AC voltage supplied to a load 3, e.g. in the form of a motor, and each switch is arranged to periodically connect the load 3 to either the positive or the negative supply rail from the DC voltage supply 2. The load 3 may be the motor of a compressor, which may be a centrifugal compressor including magnetic bearings, for example, and the motor may be a three phase inductor motor.

The inverter 1 also comprises a three phase auxiliary circuit comprising six auxiliary switches S_{X1}, S_{X2}, S_{X3}, S_{X4}, S_{X5} and S_{X6}, six auxiliary diodes D_{X1}, D_{X2}, D_{X3}, D_{X4}, D_{X5} and D_{X6} and three coupled resonant inductors T_{X1,} T_{X2} and T_{X3}. Each auxiliary switch has a diode connected across its terminals. Each auxiliary switch is arranged to connect a terminal of one of the coupled inductors to either the positive or the negative supply rail from the DC voltage supply 2, and similarly the auxiliary diodes are arranged to connect another terminal of the coupled inductors to the supply rails. The remaining terminals of the coupled inductors are connected to the main switches. The function of this inverter will be explained below with reference to a corresponding single phase inverter.

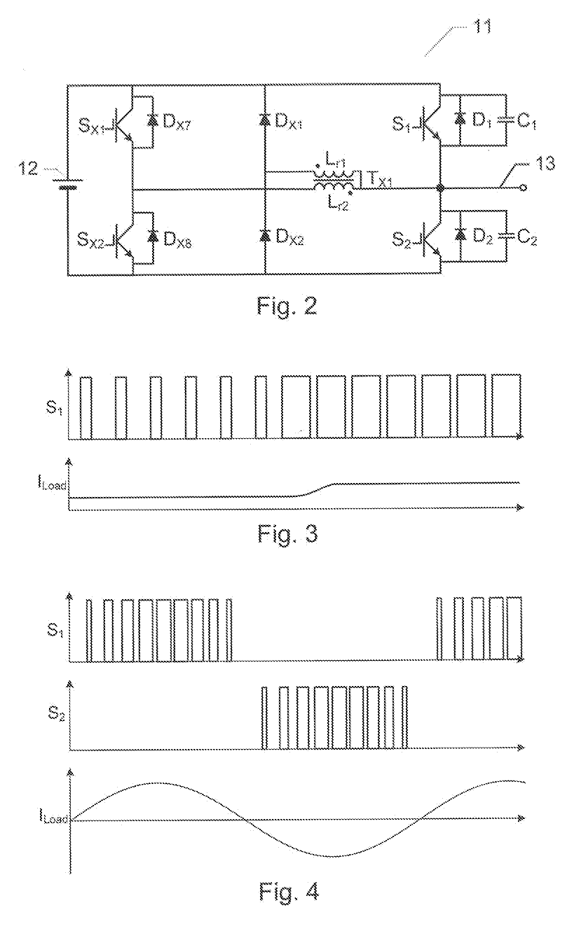

FIG. 2 shows a corresponding single phase circuit 11, which can either represent one phase of the three phase inverter 1 described above, or it can be used as a DC to DC converter or as a single phase DC to AC inverter.

The single phase inverter 11 has a main switching bridge with two main switches S₁ and S₂, each switch having a diode D₁, D₂ and a capacitor C₁, C₂ connected across its terminals. The switches S₁ and S₂ are controlled to convert a DC voltage from a supply 12, e.g. in the form of a battery, to an output voltage supplied to a load terminal 13, and each switch is arranged to periodically connect the load terminal 13 to either the positive or the negative supply rail from the DC voltage supply 12. The inverter 11 also has an auxiliary circuit comprising two auxiliary switches S_{X1} and S_{X2}, two auxiliary diodes D_{X1} and D_{X2}, and a coupled resonant inductor T_{X1} with two coupled windings Lᵣ₁ and Lᵣ₂. Each auxiliary switch has a diode D_{X7}, D_{X8} connected across its terminals. Each auxiliary switch S_{X1} and S_{X2} is arranged to connect a terminal of winding Lᵣ₂ to either the positive or the negative supply rail from the DC voltage supply 2, and similarly auxiliary diodes D_{X1} and D_{X2} are arranged to connect a terminal of winding Lᵣ₁ to the supply rails. The other terminals of windings Lᵣ₁ and Lᵣ₂ are connected to the main switches.

The function of this circuit will now be described. First, the function of the main switches S₁ and S₂ is described. One or both of these switches is switched on and off periodically by a control circuit using e.g. pulse width modulation to supply the intended level of power to the load. The control circuit is not described here, since it is well known

FIG. 3 illustrates this modulation when the circuit is used as a DC to DC converter. In this case switch S₁ can be used as the main switch, and the load can be connected between the load terminal 13 and the negative supply rail. The upper part of the figure shows the pulses in which switch S₁ is switched on, while the lower part of the figure shows a corresponding load current for an inductive load, such as an inductive motor. It is noted that during the pauses between the pulses the current to the inductive load flows through the diode D₂, so that the load current is approximately constant during a switching cycle. If it is intended to increase the load current, e.g. to increase the speed of the motor, the pulse width is increased correspondingly, which is also illustrated in the figure.

Correspondingly, FIG. 4 illustrates the modulation when the circuit is used as a DC to AC inverter. In this case switch S₁ is used as the main switch during the positive half cycles, and switch S₂ is used as the main switch during the negative half cycles. Again the upper parts of the figure show the pulses in which switch S₁ or S₂ is switched on, while the lower part of the figure shows a corresponding load current for an inductive load, such as an inductive motor. Also in this case the pulse widths are increased if it is intended to increase the load current. This is, however, not shown in the figure. In case of the three phase inverter of FIG. 1, the main switches of the three phases are modulated with an appropriate phase shift to achieve the correct three phase power to the load.

If the main switching bridge was used alone, the main switches would turn on with the full voltage across them, which should be avoided. Therefore, the auxiliary circuit mentioned above is used to provide zero-voltage-transition (ZVT) for the main bridge switches. The turn-on loss reduction in e.g. switch S₁ is achieved by turning on one of the auxiliary switches to divert the freewheeling load current in the opposite-side main diode, i.e. in this case D₂, to its own anti-paralleled diode, i.e. D₁, and then turn on the main switch S₁ under zero voltage condition.

Usually, the auxiliary circuit is composed of one pair of switches, S_{X1} and S_{X2}. Sₓᵢ only allows the auxiliary current to be injected into the main inverter leg, and S_{X2} enables the auxiliary current to flow out of the inverter leg. The auxiliary switches remain off through most of a switching cycle; one of them only turns on for load current commutation. Thus the auxiliary switches S_{X1} and S_{X2} assist the main switch to achieve zero-voltage switching. As mentioned, an auxiliary switch only turns on for a very short period. The coupled inductor Tₓᵢ serves as the resonant component to establish zero-voltage condition for the main switches and as the resetting component to reset the resonant current so that the auxiliary switches can turn off at zero-current condition.

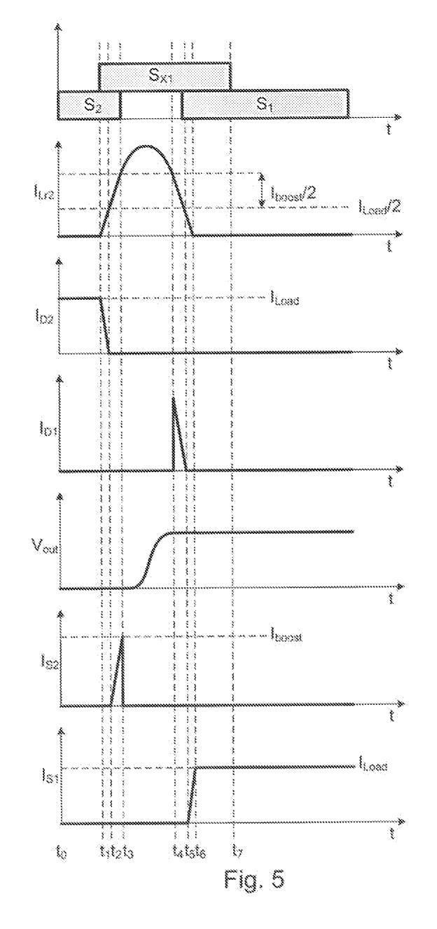

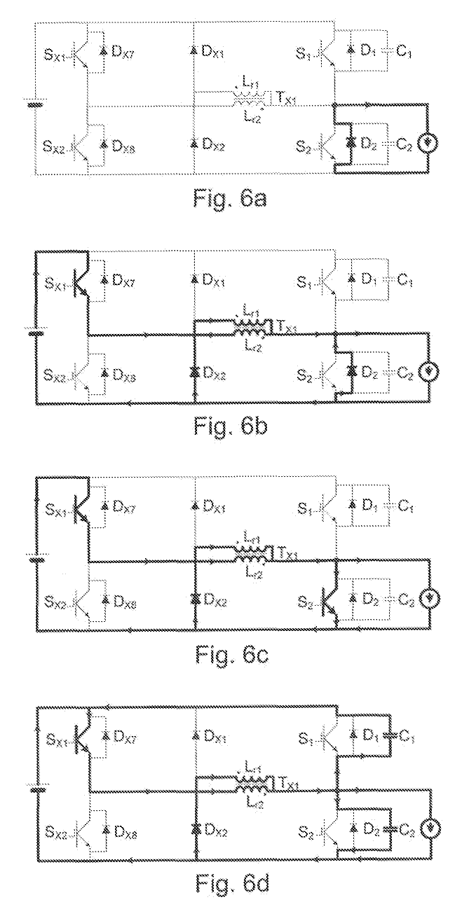

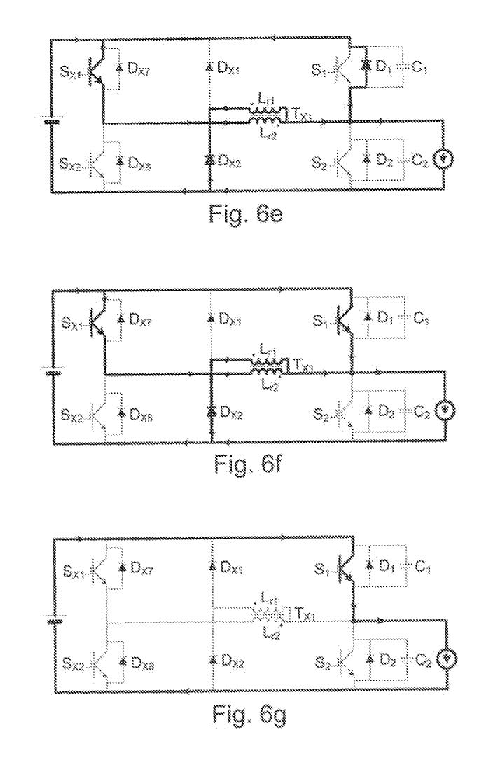

Several timing control schemes for the auxiliary circuit are known. One example, which is disclosed in Yu, H. et al. “Variable timing control for coupled-inductor feedback ZVT inverter”, PEMC, 2000, pages 1138-1143 vol. 3, is briefly described below. The principle of operation is explained in the situation where the main switch S₁ turns on, i.e. the load current is switched from the main diode D₂ to the switch S₁. This corresponds to the start of one of the pulses in FIG. 3 or one of the positive (S₁) pulses in FIG. 4. The operation waveforms are illustrated in FIG. 5, and the different stages are illustrated in FIGS. 6a to 6g. In an initial stage from t₀ to t₁, which is shown in FIG. 6a, the load current flows via diode D₂.

In a pre-charging stage (t₁ to t₂, FIG. 6b) the auxiliary switch S_{X1} is turned on at t₁. The voltage across the winding Lᵣ₂ of the resonant inductor T_{X1} will then be the dc bus voltage. This will initiate a ramp current I_{Lr2} through the inductor, i.e. the inductor current is charged linearly, until this current reaches half of the load current I_{load}. Due to the coupling between the two windings of the coupled inductor T_{X1} a similar current will flow in the winding L₁. The current through the diode D₂ is correspondingly decreased to zero at t₂ when resonant inductor current I_{Lr2} reaches half of the load current.

Next, in a boost-charging stage (t₂ to t₃, FIG. 6c) the diode D₂ is turned off naturally at t₂. Main switch S₂ is held on in this stage to allow the inductor current to exceed the load current by certain amount, i.e. the boost current I_{boost}. Thus the auxiliary inductor current I_{Lr2} increases linearly to a certain designed level (I_{load}+I_{boost})/2.

Resonant stage (t₃ to t₄, FIG. 6d): The main switch S₂ is turned off at t₃ with the current I_{boost}. Thus both main switches and both main diodes are off at t₃. When the lower main switch S₂ is turned off, the leakage inductors of the coupled inductor T_{X1} will resonate with the capacitors C₁ and C₂ across the main switches. As a result of the resonance, the output voltage, i.e. the lower capacitor voltage, will swing to the upper rail voltage, where it will be clamped by the upper main diode D₁ at t₄.

ZVT Clamping stage (t₄ to t₅, FIG. 6e): Once diode D₁ is conducting at t₄, the negative dc bus voltage is applied to the resonant inductor. The inductor current I_{Lr2} will thus decrease linearly. Before the inductor current is decreased to the level of the load current at t₅, the main switch S₁ can be turned on under zero-voltage condition.

Discharging stage (t₅ to t₆, FIG. 6f): The main diode D₁ is naturally turned off at t₅ and the main switch S₁ takes over the load current gradually. After the resonant inductor current I_{Lr2} is decreased to zero at t₆, the load current totally flows from the main switch S₁.

Final stage (t₆ to t₇, FIG. 6g): After t₆ the auxiliary switch S_{X1} can be turned off under zero-current condition at t₇. The switching of the load current from the diode D₂ to the main switch S₁ has now been completed, and S₁ can continue conducting for the duration of that pulse. To the right of FIG. 5 it is illustrated that the pulse ends, and then a new cycle can begin.

In case of a negative load current, i.e. a load current flowing into the inverter, as it occurs e.g. during the negative half periods for a DC to AC inverter, the operation of the circuit is essentially the same as described above, but the load current is then switched from the main diode D₁ to the main switch S₂, and switch S_{X2} is used as the auxiliary switch.

Although the converters and inverters described above achieve proper operations for the main switch commutations, they suffer from two types of inherent circulating currents through the auxiliary circuits, i.e. freewheeling currents and residual magnetizing currents. These circulating currents increase the losses of the auxiliary circuits and result in unexpected electromagnetic interference (EMI) sources. The currents not only degrade the inverter performance, in terms of efficiency and EMI, but also induce malfunction of the inverters, because those two parasitic issues can drive the core of the soft-switching coupled inductors into saturation.

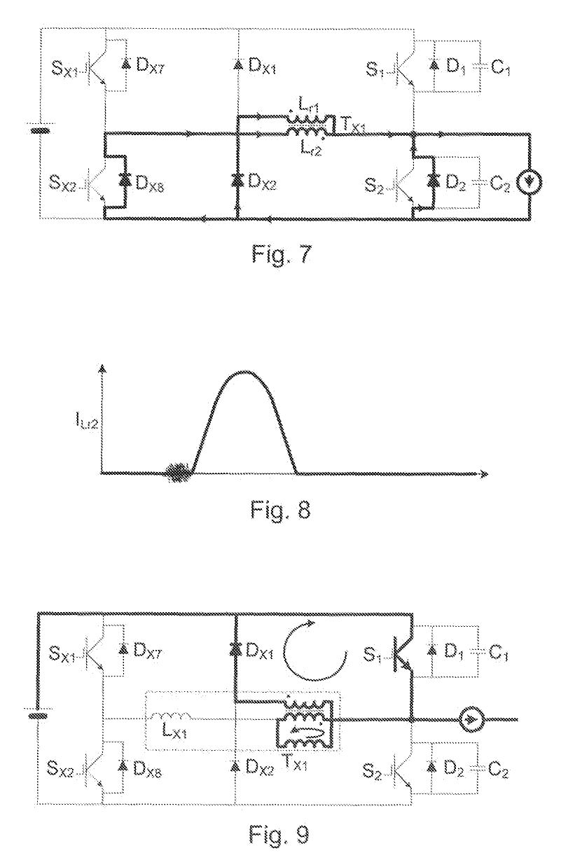

The freewheeling current can be explained as follows. When the anti-parallel diode of a main switch carries load current, such as it is the case for the diode D₂ in FIG. 6a, the conduction voltage drop of this diode is applied to the corresponding auxiliary circuit as a voltage source for a freewheeling current. Therefore, the freewheeling current through auxiliary diodes increases until an auxiliary switch turns on. FIG. 7 illustrates the freewheeling current paths through the two diodes D_{X2} and D_{X8} when D₂ carries load current. Because this current flows through the auxiliary diodes and coupled inductors, it increases the conduction loss of the auxiliary circuit. In the case of FIG. 7, the turn-on of S_{X1} causes the reverse recovery current of the diode, because D_{X8} carries the freewheeling current. Even if the amplitude of the reverse recovery current is not large, the current behaves as an EMI source. As indicated in FIG. 8, the auxiliary switch current, which equals the inductor current I_{Lr2}, has high-frequency harmonics when the auxiliary switch turns on. The harmonics degrade the EMI performance of the inverter.

The residual magnetizing current can be explained as follows. After an auxiliary switch turns off and the commutation is completed, e.g. at t₇ in FIG. 5, corresponding to the situation shown in FIG. 6g, the magnetizing current remains in the coupled inductor. This residual magnetizing current freewheels through a turned-on main switch and an auxiliary diode. For example, when auxiliary switch S_{X1} turns off, the magnetizing current freewheels through the main switch S₁ and the auxiliary diode D_{X1}, as shown in FIG. 9. Because there is no reverse bias to T_{X1}, this current cannot be reset. Thus a so-called zero volt-seconds loop is created. A zero volt-seconds loop is a loop where the inductive current is just preserving as constant from the previous state. It does not increase nor decrease until the applied voltage changes. Having such a loop into a circuit like above, the inductive current can increase very fast in few switching cycles. The extra winding shown in parallel with winding Lᵣ₂ represents the magnetizing current flowing in winding Lᵣ₂. Correspondingly, the inductor L_{X1} shown in series with winding Lᵣ₂ represents the leakage of winding Lᵣ₂. Eventually, the magnetizing current is accumulated through several switching cycles until the load current changes direction (in case of a DC to AC inverter). Thus this current can become quite a large current. The accumulated current can finally induce the malfunction of the inverter. In an attempt to reset the magnetizing current by disconnecting the auxiliary circuit from the main bridge, it has been suggested to insert a saturable inductor in series with the coupled inductor. During the reset period, the inserted saturable inductor allows the magnetizing current to flow through the auxiliary diodes, which gives reverse bias to the coupled inductor and thus resets the magnetizing current. This solution has been recognized as being insufficient, first due to excessive overheating caused by hysteretic losses in the saturable core, and second, the solution is not effective at all operating conditions, such as low output frequencies (for example, in the range of a few Hertz), when the core of the coupled inductors can experience very high magnetization current levels and saturation.

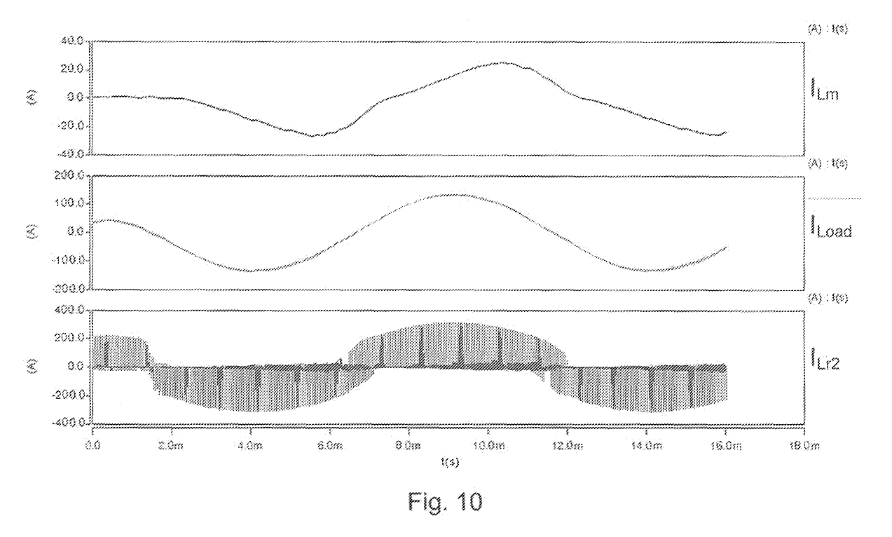

However, simulations made with the circuit with a saturable choke have shown that this solution gives insufficient improvement. FIG. 10 shows a simulation with 100 Hz at the output, and it can be seen that the magnetizing current in this solution can accumulate to a level of 20Aₚₖ. The figure shows the accumulated residual magnetizing current I_{Lm}, the output load current I_{Load} and the inductor current I_{Lr2}. It is clear that it will be very difficult to use a reasonable core size for coupled inductors in order to withstand such a current, which can be even higher under some operational conditions.

Another solution, which is described in Jae-Young Choi, et al. “A Novel Inductor-coupled ZVT Inverter with Reduced Harmonics and Losses”, PESC, 2001, pages 1147-1152, tries to remove the circulating currents without saturable inductors. In this solution the circulating path is stopped by adding an additional reset winding to the coupled inductor T_{X1}. One disadvantage of this solution is that the auxiliary switches are not clamped to the bus-voltage.

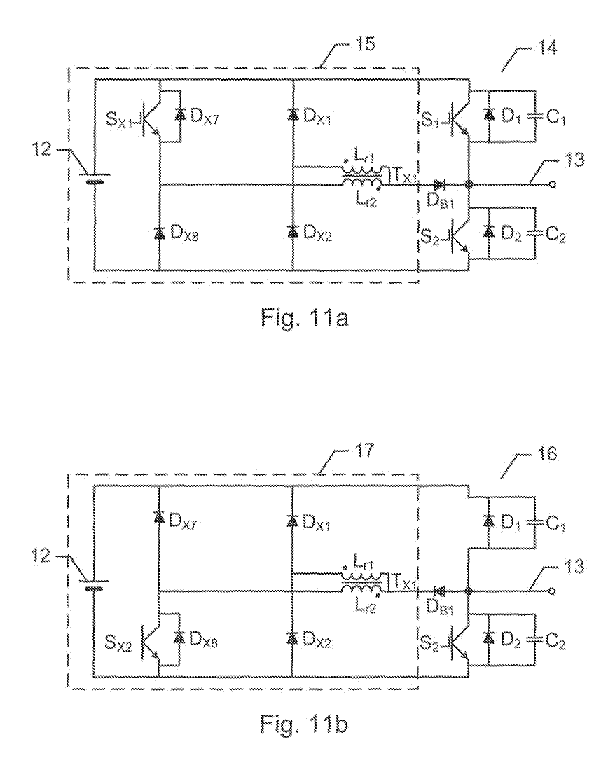

When the circuit of FIG. 2 is used as a DC to DC converter, i.e. the load current flows out of the load terminal 13, it can be seen from FIGS. 6a to 6g that the intended auxiliary currents always flow in the direction from the coupled inductor T_{X1} to the main bridge. However, as described above and shown in FIG. 9, the residual magnetizing current flows in the opposite direction. Therefore, a blocking diode D_{B1} inserted in the connection from the coupled inductor T_{X1} of the auxiliary circuit 15 to the main bridge as shown in the inverter 14 in FIG. 1 la will prevent the zero volts-seconds loop mentioned above, while still allowing the intended auxiliary currents to flow. Thus although the residual magnetizing current will still occur in each switching cycle, it will also be reset in each cycle, so that it is not allowed to accumulate over several switching cycles as in the circuits described above. It is noted that in this case, where the load current flows out of the load terminal 13, the auxiliary switch S_{X2} will not be used, and as shown in FIG. 11a, it can thus be omitted. Similarly, although main switch S₂ is still shown in FIG. 11a, it could also be omitted in this situation.

In case of a DC to DC converter supplying a negative DC voltage, i.e. the load current flows into the load terminal 13, the blocking diode D_{B1} is instead inserted in the opposite direction and it would then be the auxiliary switch S_{X1} and the main switch S₁ that could be omitted. This is illustrated in the auxiliary circuit 17 of the inverter 16 in FIG. 11b.

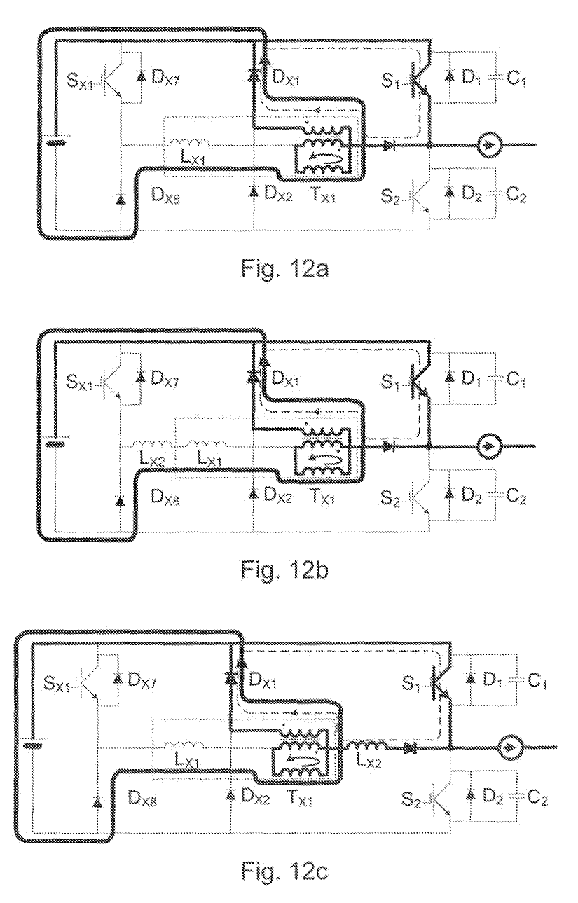

FIG. 12a shows how the zero volt-seconds loop, which was mentioned above and illustrated in FIG. 9, is now blocked by the diode D_{B1} of the circuit of FIG. 11a. This loop is shown with a dotted line in FIG. 12a. Thus the only path for the residual magnetizing current is the resetting path via the DC voltage supply 12. This path is shown with a full line in FIG. 12a. As in FIG. 9 the inductor L_{X1} shown in series with winding Lᵣ₂ indicates the inner leakage of winding Lᵣ₂ representing the resonant inductance. A discrete inductance L_{X2} may also be added in series with the primary winding of the coupled inductor T_{X1} as shown in FIG. 12b. This implementation is useful in the case where a specific coupled inductor has not sufficient leakage inductance for the design of the resonant tank. Another possibility to increase the resonant inductance is to add the discrete inductance L_{X2} in series with the blocking diode D_{B1} as shown in FIG. 12c. The discrete inductance L_{X2} can also be divided in two, so that one is added as shown in FIG. 12b and the other one as in FIG. 12c.

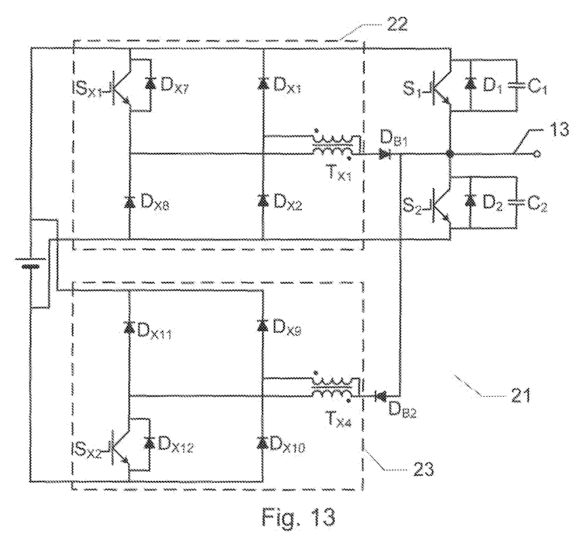

In case of a DC to AC inverter, the circuit of FIG. 11a can be used during the positive half cycles, while an additional auxiliary circuit with an additional blocking diode D_{B2} inserted in the opposite direction compared to the blocking diode D_{B1} is used during the negative half cycles. Thus a modified DC to AC inverter 21, which is shown in FIG. 13, has two auxiliary circuits, a first auxiliary circuit 22 connected to the main switching bridge through a first blocking diode D_{B1} arranged to block currents from the main switching bridge to the first auxiliary circuit and a second auxiliary circuit 23 connected to the main switching bridge through a second blocking diode D_{B2} arranged to block currents from the second auxiliary circuit to the main switching bridge. The additional auxiliary circuit 23 comprises the auxiliary switch S_{X2}, a coupled resonant inductor T_{X4} and four auxiliary diodes D₉, D_{X10}, D_{X11} and D_{X12}, and as mentioned it is connected to the main bridge through the blocking diode D_{B2}. The principle of operation is the same as described above, except that the first auxiliary circuit 22 with the auxiliary switch S_{X1} is used during the positive half periods of the AC voltage supplied to the load, while the second auxiliary circuit 23 with the auxiliary switch S_{X2} is used during the negative half periods of the AC voltage supplied to the load. This circuit can also be used as a bi-directional DC to DC converter, where the first auxiliary circuit 22 is used when positive DC voltages are supplied, while the second auxiliary circuit 23 is used when negative DC voltages are supplied.

As described for the DC to DC converter in FIG. 11a, also here the blocking diodes D_{B1} and D_{B2} in the connections from the coupled inductors T_{X1} and T_{X2} to the main bridge will prevent the zero volt-seconds loop mentioned above, while still allowing the intended auxiliary currents to flow. Thus although the residual magnetizing current will still occur in each switching cycle, it will also be reset in each switching cycle, so that it is not allowed to accumulate over several switching cycles as in the previously described circuits.

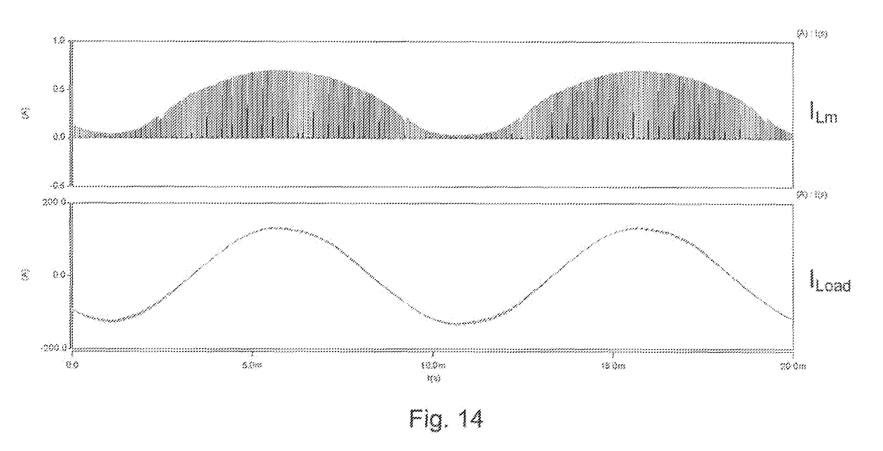

With this modified circuit the magnetizing current can be observed as being always reset in each switching cycle, and it is therefore under controlled level. This is illustrated in FIG. 14, which shows a simulation with 100 Hz at the output. The magnetizing current I_{Lm} and the load current I_{Load} are shown. It can be seen that although the magnetizing current still occur, it is now well below 1 Aₚₖ, and it is reset to zero in each switching cycle, so that it can no longer accumulate to the much higher levels known from the prior art solutions, such as it was illustrated in FIG. 10.

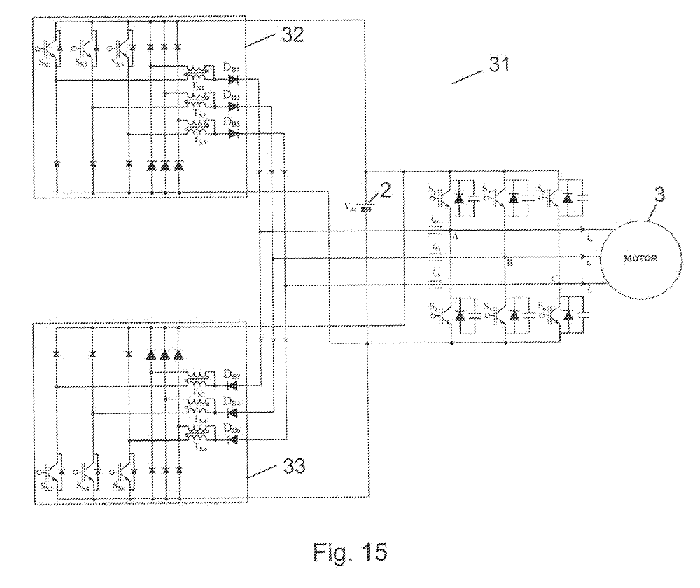

Above, the idea of resetting the magnetizing current has been described for a DC to DC converter (using a single blocking diode) and a single phase DC to AC inverter (using two separate auxiliary circuits, each connected to the main bridge through a blocking diode). However, the idea can of course also be used in a three-phase inverter as the one shown in FIG. 1. A modified three-phase inverter 31 with the auxiliary circuits 32 and 33 is shown in FIG. 15. This circuit uses six coupled inductors T_{X1}, T_{X2}, T_{X3}, T_{X4}, T_{X5} and T_{X6} and six blocking diodes D_{B1}, D_{B2}, D_{B3}, D_{B4}, D_{B5} and D_{B6}, and also the number of auxiliary diodes is increased compared to the original three-phase inverter of FIG. 1, but on the other hand the currents through the components are decreased, since the currents are shared between the components. Thus the size of e.g. the coupled inductors may be reduced. Each one of the three phases functions as described for the single phase inverter of FIG. 13.

It is noted that, as it was illustrated in FIG. 7, the freewheeling current normally flows in the same direction as the intended auxiliary currents, and therefore, this current is not blocked by the blocking diodes D_{B1} or D_{B2}, since the diode will conduct any current which will flow from anode to cathode. But the flow of the freewheeling currents is only a problem if they generate a “zero-volt-seconds loop”, because then the magnetizing current could not be reset. But here the magnetizing current is reset after each switching cycle, and thus there is no problem, even if there is a path for the freewheeling current.

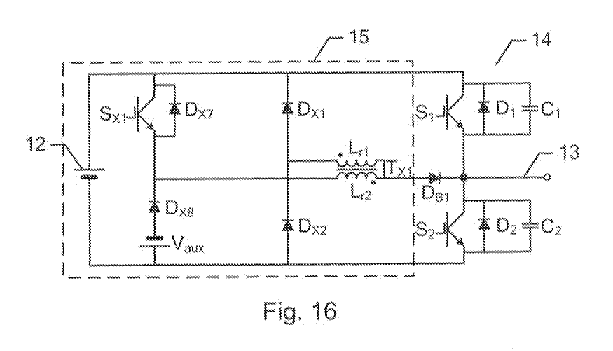

However, the circuits can be modified so that even the freewheeling current can be prevented. As shown in FIG. 16, a voltage Vₐᵤₓ can be inserted in series with the auxiliary diode D_{X8}. This voltage reduces the voltage across the auxiliary diode D_{X8}, which, as it was explained in relation to FIG. 7, was created by the conduction voltage drop over the diode D₂, and thus the auxiliary diode D_{X8} is prevented from conducting the freewheeling current. Due to the coupled inductor T_{X1}, the freewheeling current is also prevented from flowing through the auxiliary diode D_{X2}. The voltage Vₐᵤₓ can be implemented in different ways. It can be an external supply, or it can be a voltage from a supply capacitor. Especially in case of multilevel soft switching inverters, i.e. inverters in which each main switch is replaced by a stack of switches, the voltage Vₐᵤₓ can easily be generated from the voltage across one of the switches in a stack.

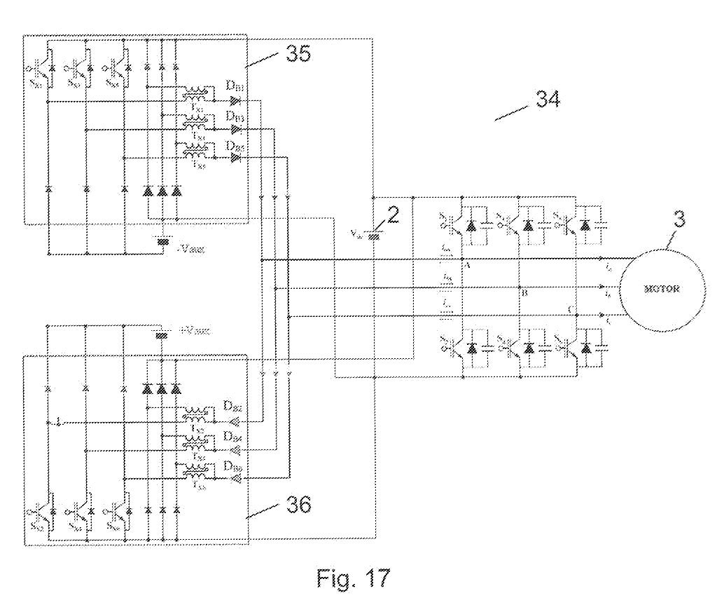

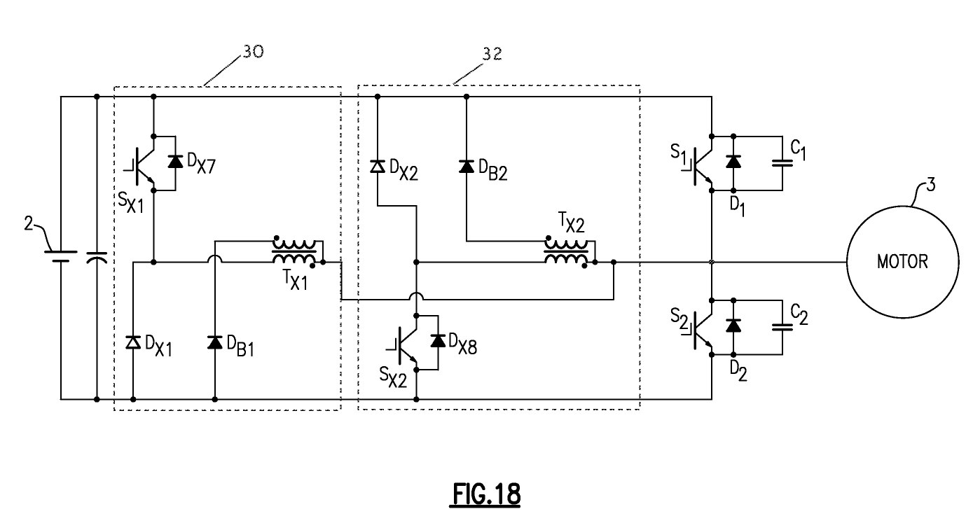

FIG. 17 shows a three-phase inverter 34 with auxiliary circuits 35 and 36, which corresponds to the inverter 31 of FIG. 15 modified with two external supplies V. in the same way as it was shown for a single phase inverter in FIG. 16.

FIG. 18 shows another embodiment of the inverter (or, a DC to AC converter) of the instant disclosure and is representative of a single-phase inverter which may be utilized in a three-phase inverter similar to that of FIG. 17. In this embodiment, two auxiliary circuits 30, 32 are arranged between the main switching bridge (including main switches S₁, S₂) and the DC voltage supply 2. Each auxiliary circuit 30, 32 includes a coupled inductor T_{X1}, T_{X2}, an auxiliary switch S_{X1}, S_{X2}, and a plurality of auxiliary diodes D_{X1}, D_{X2,} D_{X7} and D_{X8}. The auxiliary circuits 30, 32 each further include a blocking diode D_{B1}, D_{B2}, configured to block current flowing in one direction between the main switching bridge and respective auxiliary circuits 30, 32. Notably, the blocking diodes D_{B1}, D_{B2} may be arranged in a different manner than that which is shown in FIG. 13, for example. For example, the anode of blocking diode D_{B1} is connected to the negative voltage rail, and the cathode of blocking diode D_{B1} is connected to the coupled inductor T_{X1}. Further, the anode of the blocking diode D_{B2} is connected to the coupled inductor T_{X2}, and its cathode is connected to the positive voltage rail. While this embodiment does not include blocking diodes configured to block current flowing between the auxiliary circuits 30, 32 and the main switching bridge, the auxiliary circuits 30, 32 still allow the main switches S₁, S₂ to achieve zero-voltage switching in a fashion similar to the above-described embodiments.

Although various embodiments of the present disclosure have been described and shown, this disclosure is not restricted thereto, but may also be embodied in other ways within the scope of the subject-matter defined in the following claims.

1. A system comprising:
a DC voltage supply;
a compressor including a motor;
a soft switching converter including a main switching bridge positioned between the DC voltage supply and the motor, the soft switching converter further including a first auxiliary circuit, the soft switching converter converting DC voltage from the DC voltage supply into an AC voltage supplied to the motor; and
wherein the first auxiliary circuit is configured to block current flowing in one direction between the main switching bridge and the first auxiliary circuit.

2. The system of claim 1 wherein the first auxiliary circuit includes a first blocking diode configured to block current flowing in one direction between the main switching bridge and the first auxiliary circuit.

3. The system of claim 2 wherein the soft switching converter further includes:
a first voltage rail connected to a positive voltage supply of the DC voltage supply; and
a second voltage rail connected to a negative voltage supply of the DC voltage supply.

4. The system of claim 3 wherein the main switching bridge further includes:
a first main switch connected between the first voltage rail and the motor; and
a second main switch connected between the second voltage rail and the motor.

5. The system of claim 4 wherein the first auxiliary circuit includes:
at least one auxiliary switch connected to one of the first and second voltage rails.

6. The system of claim 5, wherein the at least one auxiliary switch is configured to be in an on position when transitioning from a first state where the first main switch is in an on position and the second main switch is in an off position, to a second state where the first main switch is in an off position and the second main switch is in an on position.

7. The system of claim 5, wherein the first auxiliary switch further includes a first auxiliary diode arranged to allow a current to flow in one direction between a first coupled winding and one of the first and second voltage rails.

8. The system of claim 5 wherein the soft switching converter further includes a second auxiliary circuit, the second auxiliary circuit connected to the main switching bridge through a second blocking diode arranged to block current flowing between the second auxiliary circuit and the main switching bridge.

9. The system of claim 8 wherein the first blocking diode includes a cathode connected to a first inductor of the first auxiliary circuit and an anode connected to a negative voltage rail of the soft switching converter, and wherein the second blocking diode includes a cathode connected to a positive voltage rail of the soft switching converter and an anode connected to a second inductor of the second auxiliary circuit.

10. A zero-voltage-transition soft switching converter comprising:
a first DC voltage rail connected to a positive DC voltage;
a second DC voltage rail connected to a negative DC voltage;
a load output terminal configured to be coupled to a load;
a main switching bridge connected between one of the first and second voltage rails and the load output terminal; and
an auxiliary circuit connected to the main switching bridge, the auxiliary circuit configured to block current flowing in one direction between the main switching bridge and the auxiliary circuit.

11. The converter of claim 10 wherein the main switching bridge includes a first and second main switch, and the auxiliary circuit includes at least one auxiliary switch.

12. The converter of claim 11 wherein the auxiliary circuit further includes:
a first auxiliary diode having a cathode connected to the first voltage rail, and a second auxiliary diode having an anode connected to the second voltage rail, the anode of the first auxiliary diode and the cathode of the second auxiliary diode connected to a diode connection point; and
an inductor having a first and second coupled windings, the first coupled winding connected between the load and the at least one auxiliary switch, the second winding connected between the load and the diode connection point.

13. The converter of claim 12 further including that the auxiliary circuit further includes a third auxiliary diode arranged to allow a current to flow in one direction between the first coupled windings and one of the first and second voltage rails.

14. The converter of claim 13 wherein the auxiliary circuit further includes an auxiliary voltage source inserted in series with the third auxiliary diode.

15. A three-phase soft switching converter for converting a DC voltage to a three-phase AC voltage, the three-phase soft switching inverter including three soft switching converters connected between a DC voltage supply and a load, each of the three soft switching converters including:
a main switching bridge connected between the DC voltage supply and the load; and
an auxiliary circuit connected to the main switching bridge, the auxiliary circuit configured to block a current flowing in one direction between the main switching bridge and the auxiliary circuit.
